(19) United States
(12) Patent Application Publication
(10) Pub. No.: US 2016/0364618 A1
(43) Pub. Date: Dec. 15, 2016

(54) NOCTURNAL VEHICLE COUNTING METHOD BASED ON MIXED PARTICLE FILTER

(71) Applicant: NATIONAL CHUNG SHAN INSTITUTE OF SCIENCE AND TECHNOLOGY, Taoyuan City (TW)

(72) Inventors: SHIH-SHINH HUANG, KAOHSIUNG CITY (TW); SHIH-CHE CHIEN, HSINCHU CITY (TW); CHIH-HUNG LU, ZHUDONG TOWNSHIP (TW)

(21) Appl. No.: 14/734,064

(22) Filed: Jun. 9, 2015

(51) Int. Cl. G06K 9/00; G06T 7/40; G06K 9/46; G06K 9/62

(52) U.S. Cl. CPC G06K 9/00785; G06K 9/6201; G06T 7/408; G06K 9/4652; G06T 2207/30252

(57) ABSTRACT

A nocturnal vehicle counting method based on a mixed particle filter is introduced in that, in a nocturnal environment, a rear lamp of a vehicle is the most remarkable feature of the vehicle and forms a high-brightness region of an image of the vehicle. The method involves detecting the high-brightness region of an image of the vehicle to thereby detect the rear lamp of the vehicle. The method further involves operating a particle filter structure which, coupled with the detection of a moving high-brightness region, can detect and track the rear lamp of the vehicle simultaneously, thereby enhancing competitiveness and incurring low costs.

### FIELD OF TECHNOLOGY

The present invention relates to vehicle data reading methods and more particularly to a method of determining the quantity of vehicles in a nocturnal environment with a mixed particle filter.

### BACKGROUND

Depending on the sensing techniques employed, conventional traffic flow is estimated in seven ways, namely loop coil, ultrasonic, microwave, active, passive, images, and magnetic induction & detection. Due to the technological advancement in image devices and ever-decreasing production costs, image-based sensors play an increasingly important role in traffic flow estimation, for example, counting vehicles, detecting the speeds of vehicles, estimating waiting path distance, and estimating the diverting traffic streams.

Conventional image-based vehicle detection techniques rely upon such features as marginal properties, motion outlines, and symmetry to thereby detect the features related to the appearance of vehicles especially in the daytime. However, illumination is either insufficient or uneven in the nighttime, and in consequence none of the aforesaid techniques works in the nighttime as efficient as they do in the daytime in terms of accuracy.

In the daytime, images of vehicles are crystal clear and sharp, and thus conventional image processing techniques are effective in detecting the vehicles. On the contrary, in the nighttime, not only are images of vehicles blurred, but the vehicle lamps and light rays reflected off the roads are also shining intensely and blindingly; as a result, the aforesaid conventional image processing techniques have to take into account of the lamps of neighboring vehicles and the light rays reflected off the roads. Headlight is always crucial to conventional nocturnal vehicle detection techniques, because headlight is always conspicuous and stable regardless of whether there are any street lamps or whether the weather is fine.

Conventional traffic flow estimation techniques involve combining the data resulting from background subtraction as well as subtraction of preceding and subsequent images to create a preliminary object region, eliminating ground light rays by ground light ray elimination techniques, compensating for a ground light ray misread region by a headlight detection result, eliminating shades to optimize the object region, and eventually defining the final object region by performing a morphological processing process.

The major drawbacks of the prior art include high construction costs, and high susceptibility to environment. On the contrary, although image-based sensors are cheap to mount and conducive to easy access to additional information, the prior art still has room for improvement.

### SUMMARY

In view of the aforesaid drawbacks of the prior art, it is an objective of the present invention to provide a nocturnal vehicle counting method based on a mixed particle filter. In a nocturnal environment, a rear lamp of a vehicle is the most remarkable feature of the vehicle and forms a high-brightness region of an image of the vehicle. The method involves detecting the high-brightness region of an image of the vehicle to thereby detect the rear lamp of the vehicle. The method further involves operating a particle filter structure which, coupled with the detection of a moving high-brightness region, can detect and track the rear lamp of the vehicle simultaneously.

In order to achieve the above and other objectives, the present invention provides a nocturnal vehicle counting method based on a mixed particle filter, adapted to enhance accuracy in vehicle detection by image processing, the method comprising the steps of: capturing a first image with an image device, followed by performing a color recognition of the first image, so as to obtain a first image signal; capturing a second image at a next point in time with the image device, followed by performing a color recognition of the second image, so as to obtain a second image signal; and comparing the second image signal with the first image signal, followed by fetching a rear lamp feature of the vehicle, so as to obtain a vehicle passage target image with an image particle mixing technique.

The detection of a moving high-brightness region is carried out with a threshold algorithm by analyzing a bar chart of image brightness distribution to estimate one or more appropriate thresholds for use in distinguishing a high-brightness point from a low-brightness point. In this regard, the algorithm is provided in the form of image binarization which involves treating image grayscale as distribution of probability and thus finding the best threshold by statistical principles.

The number of the pixels of the grayscale is set to n₀,n₁ . . . n₂₅₅, where n₀ denotes the number of the pixels of grayscale 0, and n₁ denotes the number of the pixels of grayscale 1. The probability of grayscale i in the grayscale image is calculated as follows:

$${p}_{i} = {n}_{i} / N where {p}_{i} \geq 0 and {\sum }_{i = 0}^{255} {p}_{i} = 1$$

nᵢ denotes the number of the pixels of grayscale i, where N denotes the total number of pixels, and pᵢ denotes the probability of pixel grayscale i. A grayscale k is selected to be a threshold, and then all the grayscales are divided into two clusters C₀, C₁, where C₀ denotes the cluster of grayscales 0˜k, and C₁ denotes the cluster of grayscales k+1˜255, wherein clusters respectively have probabilities w₀, w₁ and pixel averages μ₀, μ₁, which are expressed as follows:

$${w}_{0} = {\sum }_{i = 0}^{k} {p}_{i} {w}_{1} = {\sum }_{i = k + 1}^{255} {p}_{i}$$

$${μ}_{0} = {\sum }_{i = 0}^{k} \frac{i {p}_{i}}{{w}_{0}} {μ}_{1} = {\sum }_{i = k + 1}^{255} \frac{i {p}_{i}}{{w}_{1}}$$

The cluster variances σ₀², σ₁² are expressed as follows:

$${σ}_{0}^{2} = {\sum }_{i = 0}^{k} {( 1 - {μ}_{0} )}^{2} \frac{{p}_{i}}{{w}_{0}}$$

$${σ}_{1}^{2} = {\sum }_{i = k + 1}^{255} {( 1 - {μ}_{1} )}^{2} \frac{{p}_{i}}{{w}_{1}}$$

The weight sum of cluster variance σ_{w}²(k) expressed as follows:

σ_{w}²(k)=w₀σ₀²(k)+w₁σ₁²(k)

Hence, given the minimum value of k, the weight sum of cluster variance represent the optimal critical value.

However, in the nocturnal scenario, most of the image points exhibit low brightness, and thus the bar chart shows that its corresponding brightness part manifests single-peak distribution instead of double-peak Gaussian distribution. As a result, the Otsu algorithm yields a low threshold to thereby cause plenty of background image points to be wrongly categorized as high-brightness image points. In view of this, the present invention puts forth a threshold algorithm based on margin points so as to effectively capture high-brightness image points.

By observation, an appropriate nocturnal image threshold must be effective in distinguishing a high-brightness region from its surroundings. Hence, the method of the present invention comprises the steps of: detecting all the margin points and all the image points which undergo relative large changes in the brightness gradient in the images with a margin detection algorithm; drawing a bar chart of the distribution of the brightness at all the margin points such that the exhibited distribution features conform with the double peak distribution presumption of the algorithm; and estimating the threshold shown in the aforesaid bar chart with the algorithm so as to identify the high-brightness regions in the image.

After the high-brightness mask region Mₜ^{(b)} at time t has been identified, the next step entails subtracting the brightness mask region Mₜ₋₁^{(b)} at the preceding time t-1 from the high-brightness mask region Mₜ^{(b)} at time t with the equation described below, so as to detect the high-brightness region Mₜ^{(c)} (bright change region) which has already changed.

Mₜ^{(c)}={(x,y)|(x,y) ∈ Mₜ^{(b)},(x,y) ∉ Mₜ₋₁^{(b)}}

However, region Mₜ^{(c)} is a motion margin region. To identify the complete high-brightness motion region, the present invention is characterized in that: all the image points detected by Mₜ^{(c)} are regarded as seeds which are then expanded within the mask Mₜ^{(b)} by a region expansion algorithm put forth in 1994 so as to attain Mₜ^{(h)}, where x denotes the virtual program code attributed to the algorithm and intended to accurately identify a rear lamp region of the moving vehicle with a view to detecting the rear lamp region of a vehicle in an image scenario, so as to facilitate the tracking process carried out with a particle filter.

The functionality of a conventional particle filter is restricted to tracking an existing vehicle lamp, and the conventional particle filter is unable to effectively detect any vehicle lamp which has already entered a scenario image. In view of this, the present invention is designed to project an image, both horizontally and vertically, onto the attained high-brightness change region Mₜ^{(h)}, treat the projection bar chart as descriptive of the (c_{x,t},c_{y,t}) coordinates sampling probability of the rear lamps of the vehicle, and sample a portion of particles (with a proportion γ) from Mₜ^{(h)}, so as to carry out vehicle rear lamp detection.

The vehicle motion model is configured to be a linear motion model, wherein the movement direction (Δcₓ,Δc_{y}) is detected in accordance with a lane and artificially given. The equation of the particles estimated in accordance with the motion model is as follows:

c_{x,t}=c_{x,t-1}+Δcₓ+N(0,σ)

c_{y,t}=c_{y,t-1}+Δc_{y}+N(0,σ)

where N(0,σ) expresses a Gauss model with an average 0 and a standard deviation σ to evaluate the likelihood probability Pr(Iₜ|xₜ⁽ⁱ⁾) of the presently observed image Iₜ and define it as the average brightness of the vehicle rear lamp region R formed in accordance with the particle state, and its equation is as follows:

$$Pr ( {I}_{t} \vert {x}_{t} ) = \frac{{\sum }_{( x , y ) ∈ R} {I}_{t} ( x , y )}{\vert R \vert}$$

### BRIEF DESCRIPTION

Objectives, features, and advantages of the present invention are hereunder illustrated with specific embodiments in conjunction with the accompanying drawings, in which:

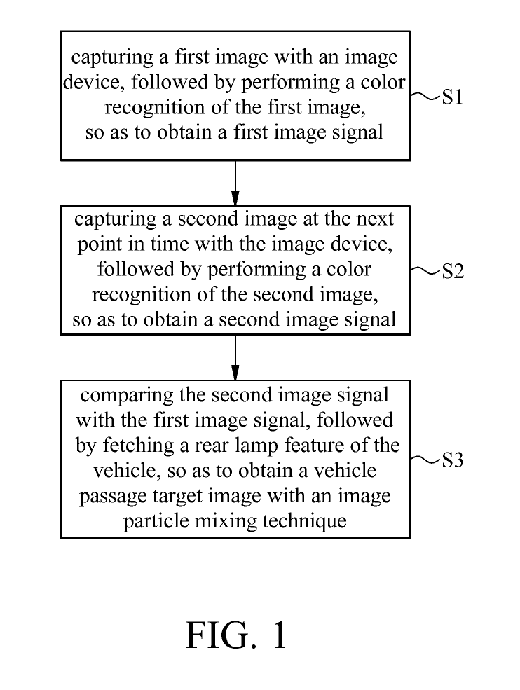

FIG. 1 is a flow chart of a nocturnal vehicle counting method based on a mixed particle filter according to the present invention.

### DETAILED DESCRIPTION

Referring to FIG. 1, there is shown a flow chart of a nocturnal vehicle counting method based on a mixed particle filter according to the present invention. The method is adapted to enhance accuracy in vehicle detection by image processing. The method comprises the steps as follows:

Step S1: capturing a first image with an image device, followed by performing a color recognition of the first image, so as to obtain a first image signal, wherein the image device is a CCD or a CMOS;

Step S2: capturing a second image at the next point in time with the image device, followed by performing a color recognition of the second image, so as to obtain a second image signal; and

Step S3: comparing the second image signal with the first image signal, followed by fetching a rear lamp feature of the vehicle, so as to obtain a vehicle passage target image with an image particle mixing technique, thereby recognizing vehicle passage and counting the vehicles, wherein the color recognition is performed for use in image signal recognition according to a single color, wherein the color recognition is sorted by a weight feature of an image in a single color so as to obtain an image template, wherein the image particle mixing technique is for use in forming a vehicle passage trajectory with rear lamp feature of the passing vehicle, so as to recognize the passage of the vehicles and count the vehicles.

The image particle mixing step is described below. Upon completion of the detection of the rear lamps of a vehicle, the moving vehicle is detected with a vehicle lamp match algorithm (described below) in accordance with the coordinates Ci(ui, vi) and Cj(uj, vj) of the center of gravity of any two vehicle rear lamps. The steps of the algorithm are as follows:

Step 1: if |vi, vj|>h, go to Step 6, otherwise go to Step 2, where h denotes the tolerance of the height of the two vehicle rear lamps;

Step 2: set VC(Ci, Cj) to a vehicle candidate which includes Ci and Cj. Then, the vehicle width of VC is defined to be |ui−uj|, wherein the vehicle height equals a half of the vehicle width;

Step 3: set the image vertical coordinates of VC vehicle bottom to vbottom, and define min{vi, vj}+|ui−uj|/2, wherein, if vbottom exceeds the detection range, go to Step 6, otherwise go to Step 4;

Step 4: if vehicle width |ui−uj| ranges between the configured vehicle width thresholds, go to Step 5, otherwise go to Step 6;

Step 5: determine VC to be a vehicle, with a return value “true,” and end the algorithm;

Step 6: Ci and Cj cannot form a vehicle, with a return value “false,” and end the algorithm such that the remaining vehicle lamps are deemed attributed to motorbikes. Hence, the present invention involves treating a pair of matched vehicle lamps as attributed to a vehicle and treating a single vehicle lamp as attributed to motorbike.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A nocturnal vehicle counting method based on a mixed particle filter, adapted to enhance accuracy in vehicle detection by image processing, the method comprising the steps of:
capturing a first image with an image device, followed by performing a color recognition of the first image, so as to obtain a first image signal;
capturing a second image at a next point in time with the image device, followed by performing a color recognition of the second image, so as to obtain a second image signal; and
comparing the second image signal with the first image signal, followed by fetching a rear lamp feature of the vehicle, so as to obtain a vehicle passage target image with an image particle mixing technique.

2. The nocturnal vehicle counting method based on a mixed particle filter of claim 1, wherein the image device is one of a CCD and a CMOS.

3. The nocturnal vehicle counting method based on a mixed particle filter of claim 1, wherein the color recognition is performed for use in image signal recognition according to a single color.

4. The nocturnal vehicle counting method based on a mixed particle filter of claim 3, wherein the color recognition is sorted by a weight feature of an image in a single color so as to obtain an image template.

5. The nocturnal vehicle counting method based on a mixed particle filter of claim 1, wherein the image particle mixing technique is for use in determining a passage feature of a moving vehicle.

6. The nocturnal vehicle counting method based on a mixed particle filter of claim 1, further comprising the step of operating a processing device.
